(19) United States
(12) Patent Application Publication
(10) Pub. No.: US 2002/0067529 A1
(43) Pub. Date: Jun. 6, 2002

(54) Passive optical network transmission system, ATM-passive optical network transmission system, optical network unit of ATM-passive optical network transmission system, and optical line terminator of ATM-passive optical network transmission system

(75) Inventors: Tetsuya Yokomoto, Kawasaki-shi (JP); Koji Aoki, Kawasaki-shi (JP); Takehiro Yamada, Kawasaki-shi (JP); Hirokazu Shimada, Kawasaki-shi (JP); Tohru Hayasaka, Kawasaki-shi (JP)

Correspondence Address: JENKENS & GILCHRIST, PC, 1445 ROSS AVENUE, SUITE 3200, DALLAS, TX, 75202, US

(73) Assignee: FUJITSU DENSO LTD.

(21) Appl. No.: 09/933,339

(22) Filed: Aug. 20, 2001

(30) Foreign Application Priority Data
Aug. 25, 2000 (JP) 2000-256328

(51) Int. Cl. H04B 10/20; H04J 14/00; H04B 10/00

(52) U.S. Cl. 359/168; 359/118

(57) ABSTRACT

On a subscriber's line between an optical network unit and an optical line terminator according to the present invention, an ATM-PON transmission frame is able to be transmitted with an STM signal inserted therein, and an STM-PON transmission frame is able to be transmitted with an ATM signal inserted therein. The ATM signal and the STM signal are transmitted coexisting with each other, whereby an STM network and an ATM network can be integrated on the subscriber's line.

### BACKGROUND OF THE INVENTION

b 1. Field of the Invention

The present invention allows signals which are transmitted in an asynchronous transfer mode (ATM) and signals which are transmitted in a synchronous transfer mode (STM) to coexist with each other on a subscriber's line constructed of optical transmission lines so that transmission on the subscriber's line is integrated with the asynchronous transfer mode (ATM) or the synchronous transfer mode (STM). Thereby, a PON (Passive Optical Network) transmission system, an ATM-PON transmission system, an optical network unit thereof, and an optical line terminator thereof are provided, which are suitable for providing multimedia services to a large number of subscribers at low prices.

Here, the coexistence of the signals transmitted in the asynchronous transfer mode (ATM) and the signals transmitted in the synchronous transfer mode (STM) means that a transmission frame (structured by a plurality of ATM cells) which is transmitted in the asynchronous transfer mode (ATM) is transmitted on the subscriber's line constructed of the optical transmission lines, with STM signals being incorporated therein which should be transmitted originally in the synchronous transfer mode (STM), and conversely, a transmission frame which is transmitted in the synchronous transfer mode (STM) is transmitted on the subscriber's line constructed of the optical transmission lines, with ATM signals being incorporated therein which should be originally transmitted in the asynchronous transfer mode (ATM). Note that the coexistence of the signals is referred to as a hybrid in this specification.

2. Description of the Related Art

Recently, prices of computers are lowering while their performances are becoming higher. In the field of communication, networks of large capacity and high-speed communication are being established by optical communication technology and digital transmission technology. As a result of this, environment for multimedia is created and various information can be received/transmitted through the networks.

In view of the above circumstances, the construction of multimedia communication networks which can easily send/receive various signals among a variety of terminals being disposed over a wide area and the networks is under study in order to realize an advanced society of multimedia in the future. The aforesaid various signals can include, for example, data, voice, still pictures, moving pictures and so the like.

In other words, B-ISDN (Broadband-ISDN) which integrates the networks such as a dedicated line network, having interfaces varying from one service to another will be put into actual use, in addition to a telephone exchange network, N-ISDN (Narrowband-ISDN) and computer communication network which are currently used. Thereby, the aforesaid networks are integrated to realize a multimedia communication network which is economical and convenient.

Therefore, an optical subscriber system is structured by the B-ISDN. Namely, while efficiently utilizing existing lines, a PON transmission system is provided, which economically constructs an optical subscriber access network by using PDS (Passive Double Star) technology.

There are two types of PON transmission systems. The first one is an STM-PON (Synchronous Transfer Mode Passive Optical Network) transmission system which transmits information in a synchronous transfer mode (STM). The second one is an ATM-PON (Asynchronous Transfer Mode Passive Optical Network) transmission system which transmits information in an asynchronous transfer mode (ATM).

FIG. 1 is a block diagram showing a conventional example of the STM-PON transmission system. Further, FIG. 2 is a block diagram showing a conventional example of the ATM-PON transmission system. First, the conventional example of the STM-PON transmission system will be explained.

As shown in FIG. 1, the STM-PON transmission system accommodates the existing lines such as a telephone line, an ISDN line, a dedicated line (wire) on a subscriber side into an optical network unit STM-ONU (Optical Network Unit) which is provided at each subscriber's premises, a telegraph pole or the like through interfaces (not shown).

The optical network unit STM-ONU includes an electric/optic converting part E/O which converts electrical signals to optical signals and an optic/electric converting part O/E which converts the optical signals to the electrical signals. Therefore, the optical network unit STM-ONU converts the electrical signals from a plurality of the existing lines (telephone line, ISDN line, dedicated line and so on) which are accommodated therein to the optical signals and sends these out to a fiber-optic cable. Further, the optical network unit STM-ONU converts the optical signals to the electrical signals, which is addressed to itself out of the optical signals received from the fiber-optic cable, and sends it out to the existing lines (telephone line, ISDN line, dedicated line and so on).

An optical star coupler SC integrates the optical signals which are sent out from the respective optical network units STM-ONU to form an STM-PON upstream transmission frame, and transmits it to an optical line terminator STM-OLT on a local exchange side. Further, the optical star coupler SC transmits an STM-PON downstream transmission frame which is sent out from the optical line terminator STM-OLT on the local exchange side to the respective optical network units STM-ONU.

The optical line terminator STM-OLT on the local exchange side receives the STM-ON upstream transmission frame through the fiber-optic cables. The optical line terminator STM-OLT includes the electric/optic converting part E/O which converts the electrical signals to the optical signals and the optic/electric converting part O/E which converts the optical signals to the electrical signals, similarly to the optical network unit STM-ONU. Therefore, the optical line terminator STM-OLT converts the received STM-PON upstream transmission frame to the electrical signals, changes positions of the signals in the STM-PON transmission frame by a time-division switch TSW, and sends it to an interoffice trunk line and a transit exchange of the synchronous transfer mode (STM) through an interface IF.

Moreover, the optical line terminator STM-OLT on the local exchange side receives the electrical signals from the interoffice trunk line and the transit exchange through the interface IF. The time-division switch TSW changes the positions of the received electrical signals. The electric/optic converting part E/O converts the electrical signals into the optical signals to form the STM-PON downstream transmission frame, and sends it to the fiber-optic cable. The STM-PON downstream transmission frame which is sent out is transmitted to the respective optical network units STM-ONU through the optical star coupler SC. Each optical network unit STM-ONU receives only the STM-PON downstream transmission frame which is addressed to itself, converts the optical signals into the electrical signals, and distributes these to the existing lines such as the telephone line, the ISDN line, the dedicated line on the subscriber side.

The up and down optical transmissions are conducted on the subscriber's line as described above by the STM-PON transmission system.

It should be mentioned that the fiber-optic cables shown in FIG. 1 transmit the optical signals at a fixed transmission rate.

Moreover, in the fiber-optic cables shown in FIG. 1, a TCM-TDMA (Time Compression Multiplex-Time Division Multiple Access) transmission system is executed, in which the STM-PON upstream transmission frame and the STM-PON downstream transmission frame are transmitted alternately in terms of time. As a result, apparent full-duplex communication is conducted on the fiber-optic cables shown in FIG. 1. Therefore, in the STM-PON transmission system, communication delays will occur on the fiber-optic cables. Namely, when the TCM-TDMA transmission system is employed, transmission capacity on the fiber-optic cable becomes half of that of the original fiber-optic cable. Therefore, the STM-PON transmission system is suitable for a communication service at a low speed.

FIG. 2 is the block diagram showing the conventional example of the ATM-PON transmission system as described above.

In FIG. 2, an optical network unit ATM-ONU accommodates the existing lines such as the telephone line, the ISDN line, and the dedicated line on the subscriber side through interfaces (not shown). Further, the optical network unit ATM-ONU includes the electric/optic converting part E/O which converts the electrical signals to the optical signals and the optic/electric converting part O/E which converts the optical signals to the electrical signals. Therefore, the optical network unit ATM-ONU converts the electrical signals from a plurality of the existing lines (telephone line, ISDN line, dedicated line and so on) which are accommodated therein to the optical signals and inserts the converted optical signals into ATM cells to form an ATM-PON upstream transmission frame (burst signal frame). Thus-formed ATM-PON upstream transmission frame is sent out to the fiber-optic cable.

Moreover, the optical network unit ATM-ONU receives the ATM cells addressed to itself which are included in an ATM-PON downstream transmission frame through the fiber-optic cable, converts the optical signals into the electrical signals, and distributes these to the existing lines (telephone line, ISDN line, dedicated line and so on).

The optical star coupler SC integrates the ATM-PON upstream transmission frames (burst signal frame) which are sent out from the respective optical network units ATM-ONU and transmits these to an optical line terminator ATM-OLT on the local exchange side. Further, the optical star coupler SC transmits the ATM-PON downstream transmission frame (structured by a plurality of ATM cells) which is sent out from the optical line terminator ATM-OLT on the local exchange side to the respective optical network units ATM-ONU.

The optical line terminator ATM-OLT on the local exchange side receives the ATM-PON upstream transmission frame which is formed by the optical star coupler through the fiber-optic cables. The optical line terminator ATM-OLT on the local exchange side includes the electric/optic converting part E/O which converts the electrical signals to the optical signals and the optic/electric converting part O/E which converts the optical signals to the electrical signals, similarly to the optical network unit ATM-ONU. Therefore, the optical line terminator ATM-OLT converts the optical signals in the ATM cells in the received ATM-PON upstream transmission frame to the electrical signals. A time-division switch ATMSW changes positions of the aforesaid electrical signals, and transmits these to an interoffice trunk line and a transit exchange of the asynchronous transfer mode (ATM) through an interface IF.

Moreover, the optical line terminator ATM-OLT on the local exchange side receives the signals from the interoffice trunk line and the transit exchange of the asynchronous transfer mode (ATM) through the interface IF. The positions of the received electrical signals are changed by the time-division switch ATMSW, the electrical signals are converted into the optical signals (ATM cells) by the electric/optic converting part E/O to form the ATM-PON downstream transmission frame, which is sent out to the fiber-optic cable. The ATM-PON downstream transmission frame which is sent out is transmitted to the respective optical network units ATM-ONU through the optical star coupler SC. Each optical network unit ATM-ONU receives only the ATM cells which are addressed to itself. The optic/electric converting part O/E converts the received ATM cells into the electrical signals, and distributes these to the existing lines such as the telephone line, the ISDN line, the dedicated line on the , subscriber side.

As described above, both the optical network unit ATM-ONU and the optical line terminator ATM-OLT include the electric/optic converting part E/O and the optic/electric converting part O/E so that the electrical signals are converted into the optical signals (ATM cells) to be transmitted on the fiber-optic cables at a fixed transmission rate (for example, 156 Mbps).

On the fiber-optic cables shown in FIG. 2, a WDM (Wavelength Division Multiplex) transmission system is employed, in which the signals in an up-direction and the signals in a down-direction are transmitted in different wavelengths. Therefore, it is unnecessary to transmit the signals in the up-direction and the signals in the down-direction alternately in terms of time, in contrast to the TCM-TDMA transmission system shown in FIG. 1, whereby the transmission capacity can be increased.

The ATM-PON transmission system as shown in FIG. 2 is a combination of the asynchronous transfer mode (ATM) technology and the PDS technology, and hence it has the following advantages.

First, it is possible to provide communication services simultaneously and at high speed, which require different transmission rates, such as the transmission of data, voice, images, moving pictures, and so on.

Second, it is possible to change the transmission rate during communications as necessary and to achieve the transmission at the optimal transmission rate, and hence, it is possible to effectively utilize resources.

However, it is extremely difficult to immediately shift from an existing wide-area communication network to the B-ISDN. The reason is that the different transmission systems of the ATM-PON transmission system and the STM-PON transmission system exist on the subscriber's line between the optical network unit ONU and the optical line terminator OLT. Because of the above different transmission systems, there are an ATM network (asynchronous network) and an STM network (synchronous network) coexisting with each other in the current wide-area communication network.

FIG. 3 is a block diagram showing a state in which the ATM network (asynchronous network) and the STM network (synchronous network) coexist with each other.

In FIG. 3, an STM local exchange 11-1(STM-LE) accommodates an optical line terminator STM-OLT (11-2) and an optical line terminator STM-OLT (11-3) through the fiber-optic cables (or coaxial cables). Further, the STM local exchange 11-1 is connected to an STM transit exchange (STM-TE) 11-5 through an STM interoffice trunk line (STM-ITL) 11-4.

Moreover, the optical line terminator STM-OLT (11-3) receives the STM-PON transmission frame from the plurality of the optical network units STM-ONU through the fiber-optic cables, as described above. Further, the STM local exchange 11-1 usually accommodates a plurality of the optical line terminators STM-OLT (11-3) and a plurality of the optical line terminators STM-OLT (11-2), which are not shown.

In FIG. 3, an ATM local exchange (ATM-LE) 11-6 accommodates an optical line terminator ATM-OLT (11-7) through the fiber-optic cable. Further, the ATM local exchange 11-6 is connected to an ATM transit exchange (ATM-TE) 11-9 through an ATM-network node interface ATM-NNI and an ATM interoffice trunk line (ATM-ITL) 11-8.

Moreover, the optical line terminator ATM-OLT (11-7) receives the ATM-PON transmission frame (a plurality of the ATM cells) which is sent out from the plurality of the optical network units ATM-ONU through the fiber-optic cables, as described above. Further, the ATM local exchange 11-6 usually accommodates a plurality of the ATM optical line terminators ATM-OLT (11-7), which are not shown.

FIG. 4 is a block diagram showing a state in which the ATM network (asynchronous network) and the STM network (synchronous network) are integrated with each other.

In FIG. 4, an example is shown, in which intra-office equipment called cell assembly and disassembly CLAD is added thereto to connect the existing STM network to the ATM network, thereby integrating the STM network and the ATM network.

As shown in FIG. 4, when the existing STM network is connected to the ATM network to integrate the STM network and the ATM network, a cell assembly and disassembly CLAD 11-10 is provided between the STM local exchange 11-1 and the ATM transit exchange 11-9. The cell assembly and disassembly CLAD 11-10 assembles data which are outputted from the STM local exchange 11-1 into the ATM cells and sends these out to the ATM transit exchange 11-9.

Moreover, the cell assembly and disassembly CLAD 11-10 assembles a plurality of the ATM cells which are outputted from the ATM local transit exchange 11-9 into the STM-PON transmission frame and sends it out to the STM local exchange 11-1. Thereby, an interconnection between the STM network and the ATM network is realized.

In the above example, the explanation is made about the case of integrating the STM network to the ATM network, but it is also possible to integrate the ATM network to the STM network by installing a cell assembly and disassembly CLAD 11-11 between the ATM local exchange 11-6 and the STM transit exchange 11-5.

However, in order to realize the integration of the STM network and the ATM network, it is necessary to install the cell assembly and disassembly CLAD which requires additional costs. The additional costs include a cost of the cell assembly and disassembly CLAD itself, its running cost and the like.

Further, when the cell assembly and disassembly CLAD is installed in the transmission network, transmission delays of the signals will occur inside the cell assembly and disassembly CLAD, thereby increasing the transmission delays in the transmission network as a whole, compared with those before the integration of the STM network and the ATM network.

Furthermore, it is impossible to integrate the STM network and the ATM network on the subscriber's line. For this reason, it is necessary to install the units of the two systems of STM-ONU and ATM-OLT, and ATM-ONU and STM-OLT in order to accommodate subscriber's lines. Thus, maintenance/running costs of the units and the lines cannot be reduced in the subscriber's line, and hence, it becomes difficult to provide the services at low prices.

Therefore, even when the cell assembly and disassembly CLAD is installed to integrate the STM network and the ATM network, it becomes costly due to the installation thereof and it is impossible to integrate the subscriber's line and the units accommodating the subscriber's lines, which causes a disadvantage that the provision of the services at the low prices becomes difficult.

### SUMMARY OF THE INVENTION

It is an object of the present invention to provide a PON transmission system, in which ATM signals transmitted in an asynchronous transfer mode (ATM) and STM signals transmitted in a synchronous transfer mode (STM) coexist with each other in units of cells on a subscriber's line, and in which PON transmission frames provided with a supervisory control information transmission field for storing information designating a way to make the signals coexist with each other are sent and received.

It is another object of the present invention to provide a PON transmission system which is able to provide multimedia services to a large number of subscribers at low prices.

It is still another object of the present invention to provide an optical network unit on a subscriber side and an optical line terminator on a local exchange side which allow the signals transmitted in the asynchronous transfer mode (ATM) and the signals transmitted in the synchronous transfer mode (STM) to be transmitted while coexisting with each other in units of cells through the subscriber's line.

It is yet another object of the present invention to provide a PON transmission system and an ATM-PON transmission system which do not allow occurrence of a transmission delay in a transmission network.

According to one aspect of the present invention, in the PON transmission system connecting an optical line terminator on a local exchange side and a plurality of optical network units on a subscriber side (subscriber's line), using fiber-optic cables and an optical star coupler therebetween, the optical line terminator on the local exchange side comprises

PON transmitting means on the local exchange side for sending out a PON downstream transmission frame to the fiber-optic cable and for receiving a PON upstream transmission frame from the fiber-optic cable.

The PON downstream transmission frame has an STM signal transmission field set in units of cells and an ATM signal transmission field set in units of cells coexisting therein, a supervisory control information transmission field storing information on making allocation of the signal transmission fields in units of cells, designating a way to make the STM signal transmission field and the ATM signal transmission field coexist, and a plurality of cells having fixed lengths. The PON upstream transmission frame has the STM signal transmission field set in units of cells and the ATM signal transmission field set in units of cells coexisting therein, the supervisory control information transmission field storing information on making allocation to the transmission fields in units of cells, designating the way to make the STM signal transmission field and the ATM signal transmission field coexist, and the plurality of cells having fixed lengths.

Also, the optical network unit on the subscriber side comprises PON transmitting means on the local exchange side for sending out a PON upstream transmission frame to the fiber-optic cable and for receiving a PON downstream transmission frame from the fiber-optic cable. The PON upstream transmission frame has the STM signal transmission field set in units of cells and an ATM signal transmission field set in units of cells coexisting therein, the supervisory control information transmission field storing information on making allocation to the transmission fields in units of cells, designating the way to make the STM signal transmission field and the ATM signal transmission field coexist, and the plurality of cells having fixed lengths. The PON downstream transmission frame has the STM signal transmission field set in units of cells and the ATM signal transmission field set in units of cells coexisting therein, the supervisory control information transmission field storing information on making allocation to the transmission fields in units of cells, designating the way to make the STM signal transmission field and the ATM signal transmission field coexist, and the plurality of cells having fixed lengths.

According to the present invention, the subscriber's line can be integrated with either an ATM network or an STM network.

According to the present invention, information for designating, in units of cells, a way of making the STM signal transmission field and the ATM signal transmission field coexist can be stored in a supervisory control information transmission field.

According to the present invention, a plurality of cells having fixed lengths can be set on a PON upstream transmission frame and a PON downstream transmission frame, respectively, and the STM signal transmission field and the ATM signal transmission field can be allocated thereto by units of cells.

According to another aspect of the present invention, for example, PON transmitting unit on the subscriber side can request the optical line terminator on the local exchange side to set the STM signal transmission field and the ATM signal transmission field, and the optical line terminator on the local exchange side can notify the PON transmitting unit on the subscriber side of the setting, in response to the request.

According to still another aspect of the present invention, the ATM-PON transmission system connects the optical line terminator on the local exchange side and the plurality of the optical network units on the subscriber side using the fiber-optic cables and the optical star coupler therebetween. The optical line terminator on the local exchange side comprises ATM-PON transmitting unit on the local exchange side for providing a cell in an ATM-PON downstream transmission frame for storing supervisory control information in order to store instructional information to accommodate the STM signals in the ATM-PON transmission frame, for sending out the ATM-PON downstream transmission frame with the STM signal transmission field and the ATM signal transmission field coexisting therein according to the instructional information, and for receiving an ATM-PON upstream transmission frame with the STM signal transmission field and the ATM signal transmission field coexisting therein according to the instructional information. Further, the optical network unit on the subscriber side comprises ATM-PON transmitting unit on the subscriber side for sending out the ATM-PON upstream transmission frame with the STM signal transmission field and the ATM signal transmission field coexisting therein according to the instructional information, and for receiving the ATM-PON downstream transmission frame with the STM signal transmission field and the ATM signal transmission field coexisting therein.

According to another aspect of the present invention, the optical network unit on the subscriber side extracts the instructional information for accommodating the STM signals from the ATM-PON transmission frame transmitted from the optical line terminator on the local exchange side, inserts the STM signals into the cells according to the extracted instructional information, and transmits the ATM-PON transmission frame with the STM signals and the ATM signals coexisting therein.

According to another aspect of the present invention, for example, the instructional information for accommodating the STM signals into the ATM-PON transmission frame is stored in the cell for storing supervisory control information in the optical line terminator, and the optical line terminator can transmit the STM signals and the ATM signals coexisting in the ATM-PON transmission frame, according to the instructional information.

### BRIEF DESCRIPTION OF THE DRAWINGS

The nature, principle, and utility of the invention will become more apparent form the following detailed description when read in conjunction with the accompanying drawings in which like parts are designated by identical reference numbers, in which:

FIG. 1 is a block diagram showing a conventional STM-PON transmission system;

FIG. 2 is a block diagram showing a conventional example of a conventional ATM-PON transmission system;

FIG. 3 is a block diagram showing a state in which an ATM network and an STM network coexist with each other according to the conventional art;

FIG. 4 is a block diagram showing a state in which the ATM network and the STM network are integrated with each other according to the conventional art;

FIG. 5 is a block diagram showing a state in which the ATM network and the STM network are integrated with each other according to the conventional art;

FIG. 6 is a block diagram showing an embodiment of the present invention;

FIGS. 7 are views showing the structures of a PON downstream transmission frame and a PON upstream transmission frame which are transmitted between an optical network unit (H-ONU, 1) and an optical line terminator (H-OLT, 2);

FIG. 8 is a block diagram showing a PMDX part (1-2A), a PDS-LT part (1-2B) and a control section (CONT) (1-1) in the optical network unit (H-ONU, 1) on a subscriber side which are shown in FIG. 6;

FIG. 9 is a block diagram showing in detail a PMDX part (2-2A), a PDS-LT part (2-2B) and a control section (CONT) (2-1) in the optical line terminator (H-OLT, 2) on a local exchange side which are shown in FIG. 6;

FIG. 10 is a view showing an example of bit data which designates allocation of ATM signals and STM signals;

FIG. 11 is a view showing an example of an ATM-PON downstream transmission frame when the ATM-PON downstream transmission frame is transmitted with the STM signal inserted thereon;

FIG. 12 is an explanatory view showing an example of an STM-PON downstream transmission frame when the STM-PON downstream transmission frame is transmitted with the ATM signal inserted thereon; and

FIG. 13 is a block diagram showing the structure of the STM network and the ATM network integrated with each other on a subscriber's line according to the embodiment.

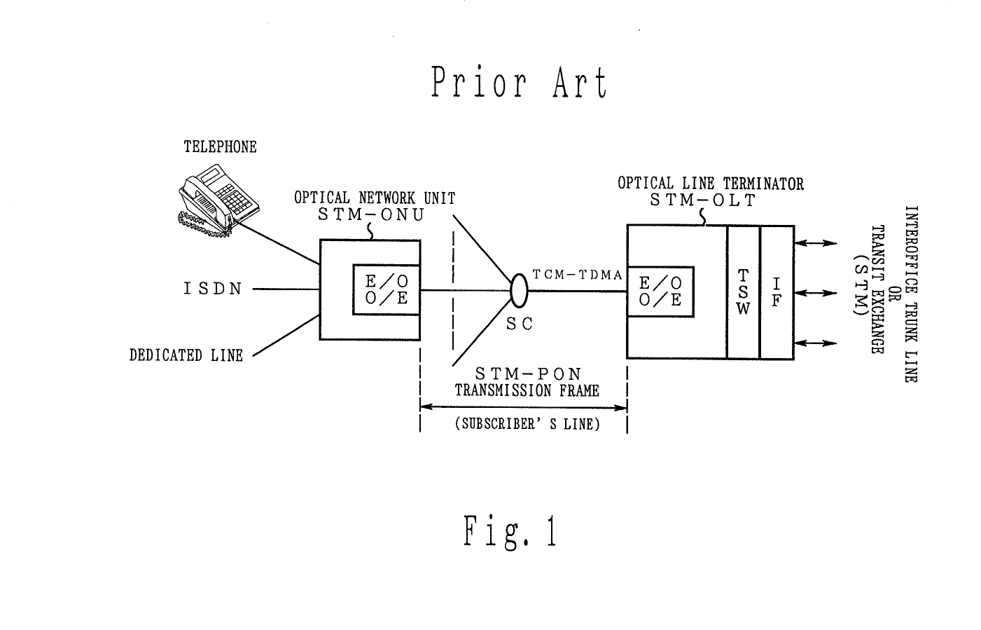

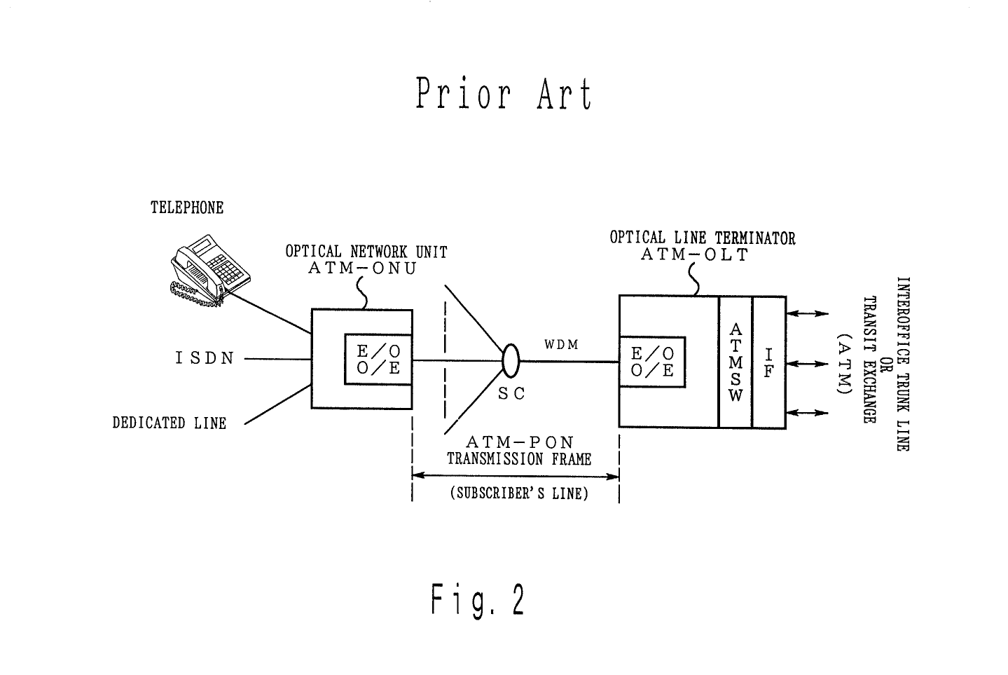

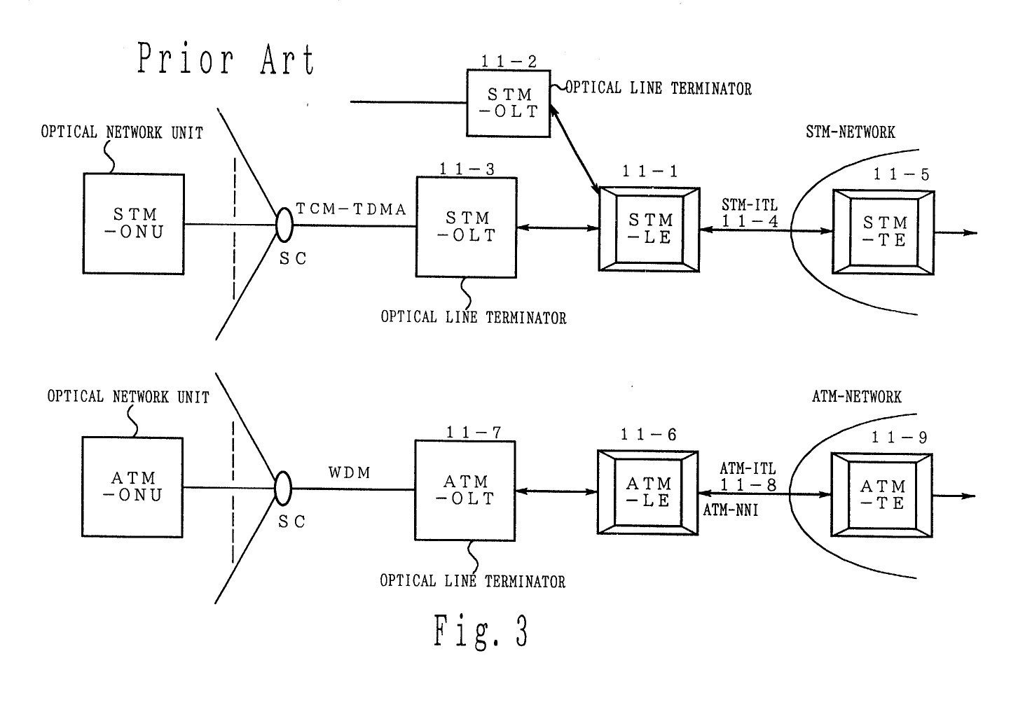

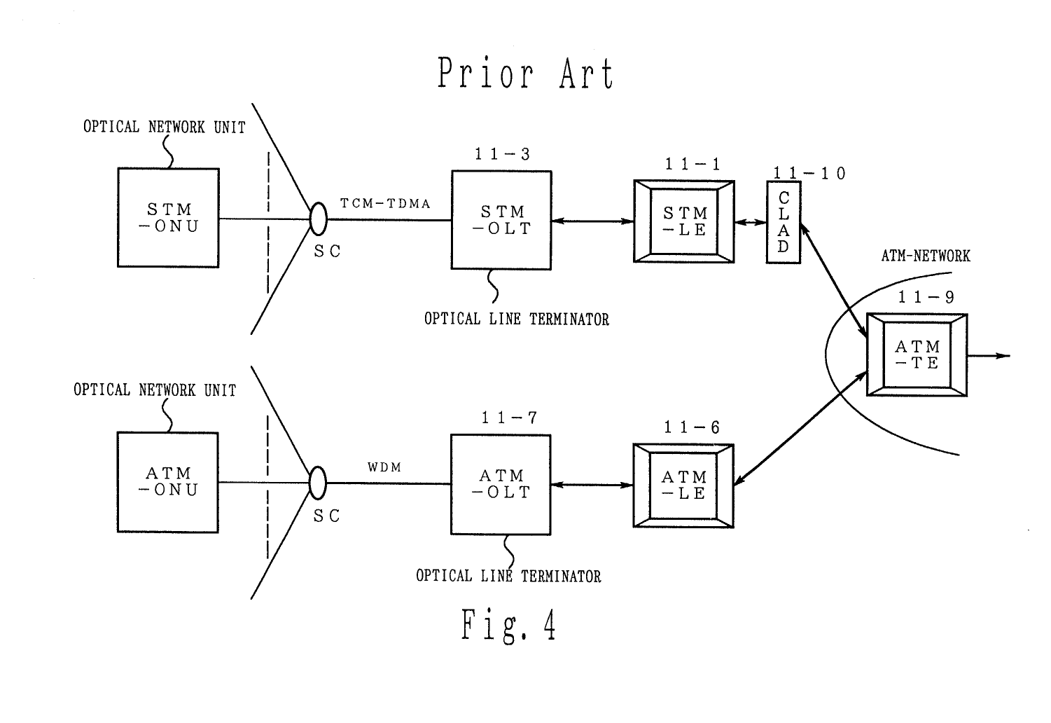

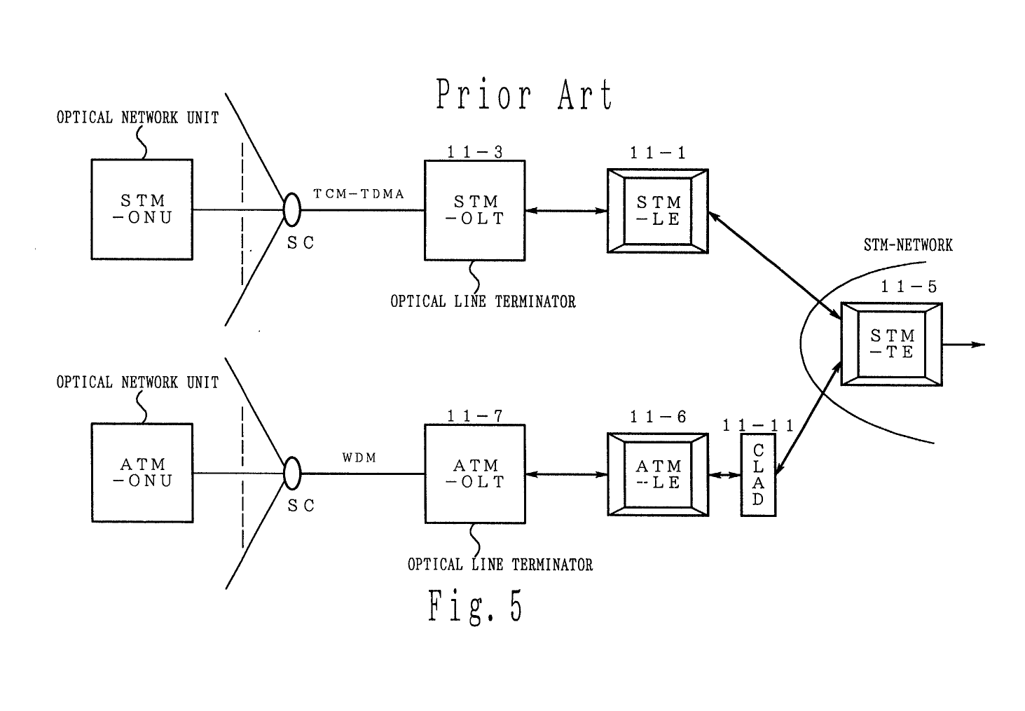

### DESCRIPTION OF THE PREFERRED EMBODIMENTS

Hereinafter, preferred embodiments of the present invention will be explained.

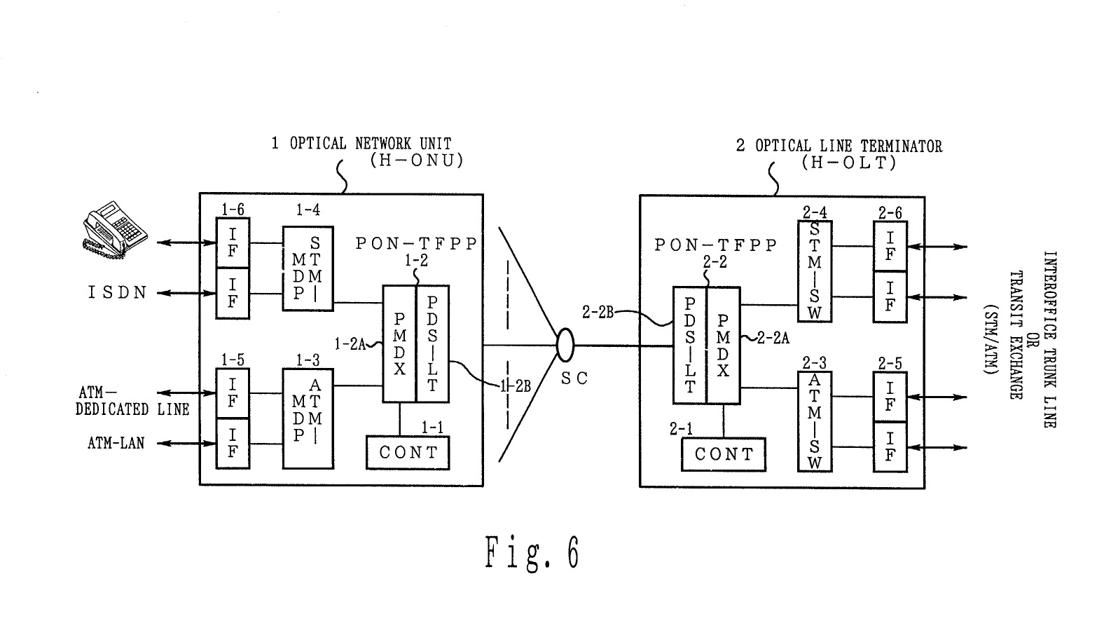

FIG. 6 is a block diagram showing an embodiment of a PON transmission system according to the present invention.

As shown in FIG. 6, an optical network unit 1 and an optical line terminator 2 are connected through an optical star coupler SC and fiber-optic cables.

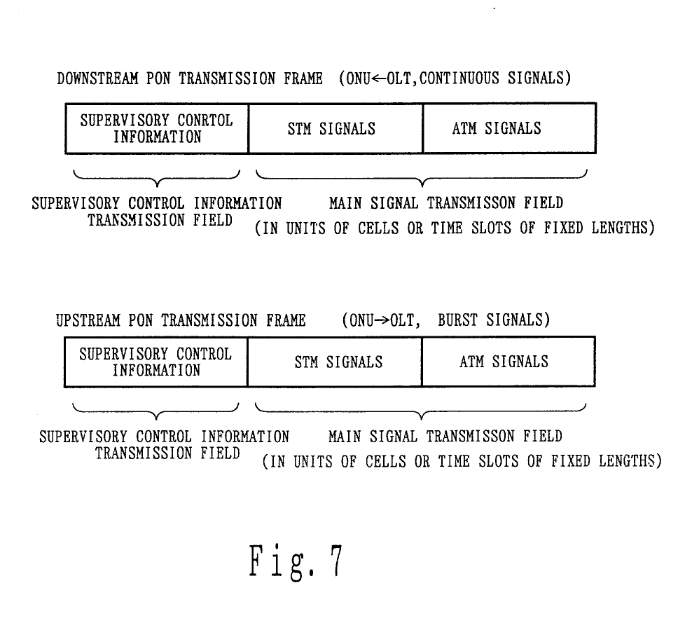

FIGS. 7 are explanatory views showing the simplified structures of a PON downstream transmission frame and a PON upstream transmission frame which are transmitted between the optical network unit 1 and the optical line terminator 2.

In FIG. 6, the optical network unit 1 on a subscriber side is a hybrid optical network unit (H-ONU). The optical network unit (H-ONU) 1 on the subscriber side accommodates a telephone line, an ISDN line, an ATM dedicated line and an ATM-LAN. These are accommodated therein through interface accommodating parts 1-5, 1-6 in the optical network unit (H-ONU) 1 on the subscriber side.

Moreover, the optical line terminator 2 is a hybrid optical line terminator (H-OLT). The optical line terminator (H-OLT) 2 is connected to an interoffice trunk line and a transmit exchange of an STM system, and also connected to an interoffice trunk line and a transmit exchange of an ATM system. These are connected thereto through an ATM interface accommodating part 2-5 and an STM interface accommodating part 2-6 in the optical line terminator (H-OLT) 2.

It should be mentioned that the hybrid unit transmitting the PON transmission frame with ATM signals and STM signals coexisting therein.

The optical network unit (H-ONU) 1 is comprised of a control section (CONT) 1-1, a PON transmission frame processing part (PON-TFPP) 1-2, an ATM multiplexing and demultiplexing part (ATM-MDP) 1-3, an STM multiplexing and demultiplexing part (STM-MDP) 1-4, an ATM interface accommodating part 1-5 and an STM interface accommodating part 1-6.

The control section (CONT) 1-1 controls functions of the respective parts in the optical network unit (H-ONU) 1. One example is that the control section 1 -1 controls to separate supervisory control information (later-described) from the PON transmission frame which is transmitted from the optical line terminator (H-OLT) 2 side.

The PON transmission frame processing part 1-2 is an execution part of PON transmission frame processing, and is comprised of a PMDX part (PON-MDX) 1-2A and a PDS-LT (Passive Double Star-Line Terminator) part 1-2B.

The PDS-LT part 1-2B includes an optic/electric converting part O/E and an electric/optic converting part E/O, and has a function of terminating the PON transmission frame which is sent from the optical line terminator (H-OLT) 2. It should be mentioned that the termination by the PDS-LT part 1-2B includes processing such as conversion from optical signals to electrical signals and information error detection in the transmitted PON transmission frame.

The PMDX part (PON-MDX, P-multiplexing and demultiplexing part) 1-2A has a function of separating main signals (STM signals, ATM signals) existing in a main signal transmission field and the supervisory control information existing in a supervisory control information transmission field from the electrical signals (PON transmission frame) which are outputted from the PDS-LT part 1-2B. These are separated therefrom according to directions from the control section 1-1.

The PMDX part (P-multiplexing and demultiplexing part) 1-2A sends out the ATM signals out of the main signals to the ATM multiplexing and demultiplexing part (ATM-MDX) 1-3 and sends out the STM signals out of the main signals to the STM multiplexing and demultiplexing part (STM-MDX) 1-4.

The above explains the processing in which the PON transmission frame processing part 1-2 receives the PON downstream transmission frame from the optical line terminator (H-OLT) 2. It is, however, needless to say that the PON transmission frame processing part 1-2 receives the ATM signals sent out from the ATM multiplexing and demultiplexing part (ATM-MDX) 1-3 and the STM signals sent out from the STM multiplexing and demultiplexing part (STM-MDX) 1-4 to form the PON upstream transmission frame. In this case, processing is performed in the PON transmission frame processing part 1-2 by reversing the aforesaid operational sequences of receiving the PON downstream transmission frame.

The ATM multiplexing and demultiplexing part (ATM-MDX) 1-3 routes (decides the route of) the ATM signals (ATM cells) of the PON downstream transmission frame, and sends them out to respective interfaces IF (ATM dedicated line, ATM-LAN) of the ATM interface accommodating part 1-5.

Moreover, when the PON upstream transmission frame is formed, the ATM multiplexing and demultiplexing part (ATM-MDX) 1-3 multiplexes the ATM cells which are sent out from the respective interfaces IF of the ATM interface accommodating part 1-5, and sends them out to the PON transmission frame processing part 1-2.

As shown in the drawing, the ATM interface accommodating part 1-5 accommodates a plurality of the interfaces IF of the ATM-LAN, the ATM dedicated line and so on. Note that a plurality of ATM terminals and the like which are not shown are connected to the ATM-LAN and the ATM dedicated line.

Electrical signals inputted from the ATM terminals and the like to the interfaces IF and electrical signals outputted from the ATM multiplexing and demultiplexing part 1-3 to the interfaces IF are reciprocally transmitted between the ATM terminals and the ATM multiplexing and demultiplexing part 1-3.

The STM multiplexing and demultiplexing part (STM-MDX) 1-4 routes (decides the route of) the STM signals outputted from the PMDX part 1-2A, and sends them out to respective interfaces IF of the STM interface accommodating part 1-6. Further, when the PON upstream transmission frame is formed, the STM multiplexing and demultiplexing part (STM-MDX) 1-4 multiplexes the STM signals which are received from the respective interfaces IF of the STM interface accommodating part 1-6, and sends it out to the PON transmission frame processing part 1-2.

The STM interface accommodating part 1-6 accommodates a plurality of the interfaces IF, as shown in the drawing, each of which corresponds to a telephone set, an STM terminal (not shown) connected to the ISDN line and so on. Electrical signals inputted from the STM terminal and the like to the interfaces IF and electrical signals outputted from the STM multiplexing and demultiplexing part 1-4 to the interfaces IF are reciprocally transmitted between the STM terminal and the like and the STM multiplexing and demultiplexing part 1-4.

The optical line terminator (H-OLT) 2 on a local exchange side is comprised of a control section (CONT) 2-1, a PON transmission frame processing part (PON-TFPP) 2-2, an ATM switch (ATM-SW) 2-3, an STM switch (STM-SW) 2-4, an ATM interface accommodating part 2-5 and an STM interface accommodating part 2-6.

The control section 2-1 receives control information from high-order operational equipment (not shown) such as supervisory control equipment, and controls the respective parts in the optical line terminator (H-OLT) 2. Further, the control section 2-1 has a function of sending supervisory control information to the optical network unit (H-ONU) 1 by the PON transmission frame.

The PON transmission frame processing part 2-2 is an execution part of PON transmission frame processing, and is comprised of a PMDX (PON-MDX) part 2-2A and a PDS-LT (Passive Double Star-Line Terminator) part 2-2B.

The PDS-LT part 2-2B includes an optic/electric converting part O/E and an electric/optic converting part E/O, and has a function of terminating the PON transmission frame which is sent from the optical network unit (H-ONU) 1 on the subscriber side. It should be mentioned that the termination by the PDS-LT part 2-2B includes processing such as the conversion from the optical signals to the electrical signals and the information error detection in the transmitted PON transmission frame.

The PMDX (PON-MDX) part 2-2A has a function of separating main signals existing in a main signal transmission field and the supervisory control information from the electrical signals (PON transmission frame) which are sent out from the PDS-LT part 2-2B. These are separated therefrom according to directions from the control section 2-1. The PMDX part 2-2A sends out the ATM signals out of the main signals to the ATM switch (ATM-SW) 2-3, the STM signals out of the main signals to the STM switch (STM-SW) 2-4 and the supervisory control information to the control section 2-1.

The above explained the processing in which the PON transmission frame processing part 2-2 receives the PON upstream transmission frame sent out from the optical network unit (H-ONU) 1. It is, however, needless to say that, when the PON transmission frame processing part 2-2 receives the ATM signals sent out from the ATM switch (ATM-SW) 2-3 and the STM signals sent out from the STM switch (STM-SW) 2-4 to form the PON downstream transmission frame, processing is performed by reversing the aforesaid operational sequences of receiving the PON upstream transmission frame.

Moreover, the ATM switch (ATM-SW) 2-3 exchanges and routes (decides the route of) the ATM cells. For example, in the case of the PON upstream transmission frame, the ATM switch (ATM-SW) 2-3 distributes the ATM cells which are received from the PON transmission frame processing part 2-2 to the two interfaces IF of the ATM interface accommodating part 2-5. Further, the ATM switch (ATM-SW) 2-3 receives the ATM cells through the respective interfaces IF of the ATM interface accommodating part 2-5, and sends them out to the PON transmission frame processing part 2-2. Furthermore, the ATM switch (ATM-SW) 2-3 and the interoffice trunk line and the transmit exchange of the ATM system reciprocally send and receive the ATM cells through the ATM interface accommodating part 2-5.

The STM switch (STM-SW) 2-4 performs cross-connect processing of the STM signals. Specifically, the STM switch (STM-SW) 2-4 sends out the STM signals which are separated from the PON upstream transmission frame to either interface IF of the two interfaces IF of the STM interface accommodating part 2-6. Further, the STM switch (STM-SW) 2-4 sends out the STM signals which are sent out from the two interfaces IF of the STM interface accommodating part 2-6 to the PON transmission frame processing part 2-2.

As shown in FIGS. 7, both the PON downstream transmission frame and the PON upstream transmission frame have the supervisory control information transmission field and the main signal transmission field.

The PON downstream transmission frame is the signals which are transmitted from the optical line terminator (H-OLT) 2 to the optical network unit (H-ONU) 1, and the PON upstream transmission frame is the signals which are transmitted from the optical network unit (H-ONU) 1 to the optical line terminator (H-OLT) 2.

As shown in FIGS. 7, when the PON transmission frame is an STM-PON transmission frame, the STM signal is inserted into at least one STM cell thereof. Further, when the PON transmission frame is an ATM-PON transmission frame, the ATM signal is inserted into at least one time slot thereof.

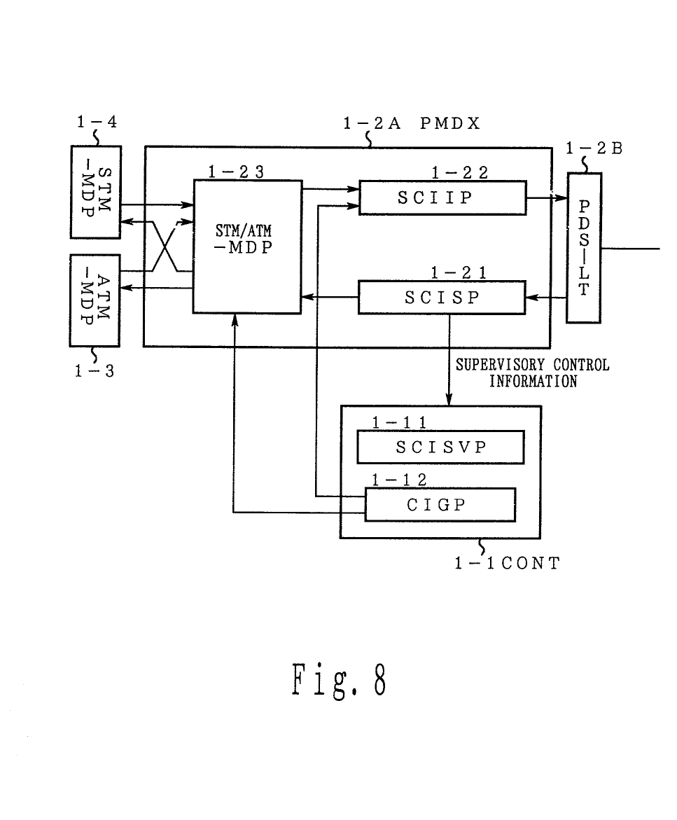

FIG. 8 is a block diagram showing in detail the PMDX part 1-2A, the PDS-LT part 1-2B and the control section 1-1 in the optical network unit (H-ONU) 1 on the subscriber side which are shown in FIG. 6.

The PON downstream transmission frame which is sent from the optical line terminator (H-OLT) 2 on the local exchange side is received in the PDS-LT part 1-2B in the optical network unit (H-ONU) 1 on the subscriber side. The PDS-LT part 1-2B receives the PON downstream transmission frame and performs processing such as frame synchronization, descrambling and the like. It should be mentioned that the descrambling unit returning the signals which are scrambled in the optical line terminator (H-OLT) 2 on the local exchange side in order to enhance security to the original signals.

A supervisory control information separating part (SCISP) 1-21 in the PMDX part 1-2A separates the supervisory control information from the time slots or the ATM cells in the supervisory control information transmission field which is included in the electrical signals outputted from the PDS-LT part 1-2B, and outputs it to the control section 1-1. The supervisory control information separating part 1-21 sends out the time slots or the ATM cells except the supervisory control information to an STM/ATM multiplexing and demultiplexing part 1-23.

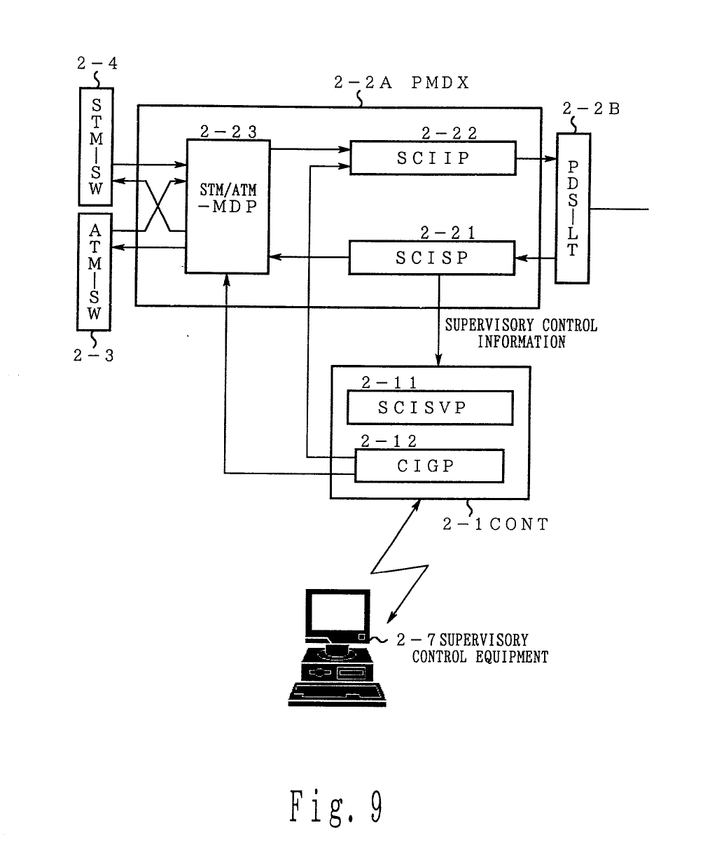

A supervisory control information supervising part (SCISVP) 1-11 in the control section 1-1 supervises the aforesaid supervisory control information transmission field in the PON transmission frame. The control section 2-1 in the optical line terminator (H-OLT) 2 on the local exchange side receives the control information from the high-order operational equipment (not shown) such as the supervisory control equipment to set the supervisory control information transmission field. And, the setting is made by the supervisory control equipment (refer to supervisory control equipment 2-7 in FIG. 9).

A control information generating part (CIGP) 1-12 sends out the supervisory control information which is obtained by the supervisory control information supervising part 1-11 supervising the aforesaid supervisory control information transmission field to a supervisory control information inserting part (SCIIP) 1-22 and the STM/ATM multiplexing and demultiplexing part 1-23. When the PON transmission frame is ATM, the supervisory control information inserting part 1-22 inserts the control information regarding which ATM cells are used for transmitting the STM signals into the supervisory control information, in sending out the PON upstream transmission frame. Further, when the PON transmission frame is STM, the supervisory control information inserting part 1-22 inserts the supervisory control information regarding which time slots are used for transmitting the STM signals, in sending out the PON upstream transmission frame.

When the PON transmission frame is ATM, the STM/ATM multiplexing and demultiplexing part 1-23 inserts the STM signals into the ATM cells which are designated by the information included in the aforesaid supervisory control information, and sends them out to the supervisory control information inserting part 1-22. Further, when the PON transmission frame is STM, the STM/ATM multiplexing and demultiplexing part 1-23 inserts the ATM signals into the time slots which are designated by the information included in the supervisory control information, and sends them out to the supervisory control information inserting part 1-22.

The following is the operation of the control information generating part 1-12 in the control section 1-1 when, for example, a new interface IF is added to the ATM interface accommodating part 1-5 or the STM interface accommodating part 1-6. The control information generating part 1-12 generates control information which requests to set an STM transmission field and an ATM transmission field in the main signal transmission field, and sends thus-generated control information to the supervisory control information inserting part 1-22 in the PMDX part 1-2A. The control information is inserted onto the supervisory control information transmission field in the PON transmission frame and sent to the optical line terminator (H-OLT) 2.

In this case, the control section 2-1 of the optical line terminator (H-OLT) 2 retrieves the control information which requests the aforesaid setting, sets new control information which complies with the aforesaid request into the supervisory control information transmission field on the PON downstream transmission frame, and sends it to the optical network unit 1.

FIG. 9 is a block diagram showing in detail the PMDX part 2-2A, the PDS-LT part 2-2B and the control section 2-1 in the optical line terminator (H-OLT) 2 on the local exchange side which are shown in FIG. 6. The basic structures of the PMDX part 2-2A, the PDS-LT part 2-2B and the control section 2-1 are the same with those of the PMDX part 1-2A, the PDS-LT part 1-2B and the control section 1-1 in the optical network unit (H-ONU) 1, respectively.

As shown in FIG. 9, a control information generating part (CIGP) 2-12 in the control section 2-1 is controlled by the supervisory control equipment 2-7. Namely, according to directions from the supervisory control equipment 2-7, the control information generating part 2-12 outputs a plurality of bit data to a supervisory control information inserting part (SCIIP) 2-22, for designating allocation states of the STM signals/the ATM signals to the time slots/the ATM cells in the PON transmission frame.

In concrete, when the PON transmission frame is the ATM-PON transmission frame, the control information generating part 2-12 outputs the bit data for allocating cell numbers into which the STM signals are inserted. Further, when the PON transmission frame is the STM-PON transmission frame, the control information generating part 2-12 outputs the plurality of the bit data for allocating time slot numbers into which the ATM signals are inserted.

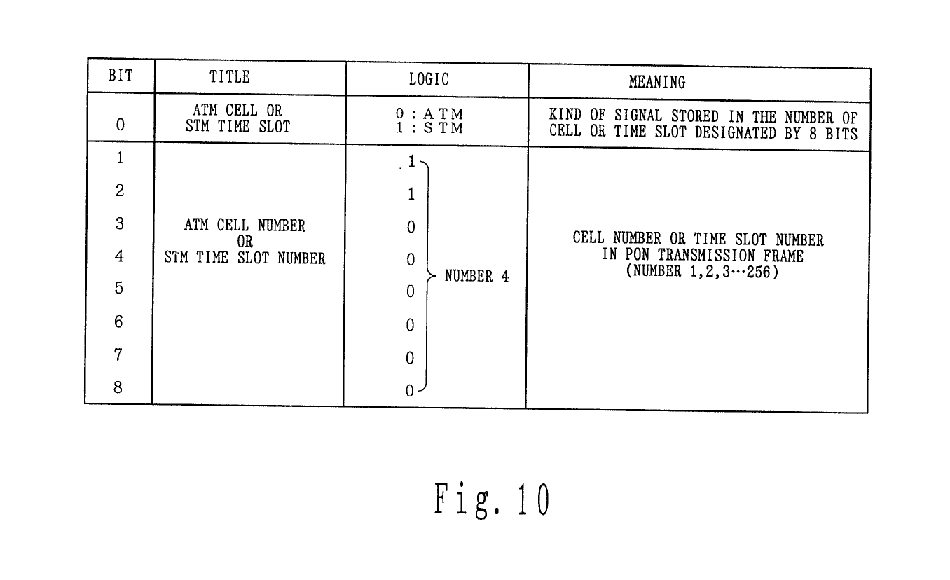

FIG. 10 is an explanatory view showing an example of the bit data. As shown in FIG. 10, the bit data has the structure of nine bits, from bit “0” to bit “8”. Specifically, the bit “0” designates whether the number which is designated by eight bits, from the bit “1” to the bit “8”, is an ATM cell number or a STM time slot number.

Supposing that, for example, when the bit “0” is a logical value 0, the number designated by the eight bits is the ATM cell number. In this case, the ATM-PON transmission frame is transmitted with the STM signal inserted into the ATM cell to which the above number is given. Further, supposing that, when the bit “0” is a logical value 1, the number designated by the eight bits is the time slot number. In this case, the STM-PON transmission frame is transmitted with the ATM signal inserted into the time slot to which the above number is given. In the example shown in FIG. 10, the STM signal may be inserted into the cell number 4 in the ATM-PON transmission frame, or the ATM signal may be inserted into the time slot number 4 in the STM-PON transmission frame.

Note that the designation of the cell number or the time slot number is not limited to the one-by-one designation as described above, but can be made in any way. For example, it is suitable to designate two numbers of number 4 and number 20 as the cell numbers or the time slot numbers so that the numbers from number 4 to number 20 are successively designated.

The supervisory control information inserting part 2-22 receives the bit data and inserts the supervisory control information into the supervisory control information transmission field in the PON downstream transmission frame shown in FIG. 7.

A supervisory control information separating part (SCISP) 2-21 in the PMDX part 2-2A separates the supervisory control information from the time slots or the ATM cells in the supervisory control information transmission field which is included in the electrical signals (upstream transmission frame) outputted from the PDS-LT part 2-2B, and outputs it to the control section 2-1. The supervisory control information separating part 2-21 sends out the time slots or the ATM cells except the supervisory control information to an STM/ATM multiplexing and demultiplexing part 2-23.

The control section 2-1 receives the supervisory control information and supervises the signal which is sent from the optical network unit (H-ONU) 1, requesting to set the STM transmission field and the ATM transmission field. When the signal requesting to set the STM transmission field and the ATM transmission field is detected as a result of supervising, this requesting signal is sent to the supervisory control equipment 2-7.

Receiving the requesting signal, the supervisory control equipment 2-7 newly sets the STM transmission field and the ATM transmission field, and this setting is sent to the control information generating part 2-12.

The control information generating part 2-12 generates the setting information which designates the new setting and the control information which includes allocating information for allocating the STM transmission field and the ATM transmission field according to the setting information in the supervisory control information transmission field on the PON downstream transmission frame, and sends it to the supervisory control information inserting part 2-22 and the STM/ATM multiplexing and demultiplexing part 2-23.

To Receiving the control information sent from the control information generating part 2-12, the STM/ATM multiplexing and demultiplexing part 2-23 allocates the STM signals and the ATM signals to the main signal transmission field in the PON downstream transmission frame, and sends it to the supervisory control information inserting part 2-22.

The supervisory control information inserting part 2-22 in the PMDX part 2-2A inserts the setting information about the transmission fields of the STM signals and the ATM signals into the supervisory control information transmission field on the PON downstream transmission frame, according to the control information generated in the control information generating part 2-12.

Moreover, the STM/ATM multiplexing and demultiplexing part 2-23 separates the STM signals and the ATM signals from the PON upstream transmission frame, and routes (decides the route of) these signals to the ATM switch (ATM-SW) 2-3 and the STM switch (STM-SW) 2-4. In other words, the separated STM signals and ATM signals are distributed to the ATM switch (ATM-SW) 2-3 and the STM switch (STM-SW) 2-4.

The operational sequences in which the control section 2-1 extracts the supervisory control information from the supervisory control information transmission field of the PON upstream transmission frame and sends the supervisory control information to the STM/ATM multiplexing and demultiplexing part 2-23 are the same with those of the supervisory control information separating part 1-21 (corresponding to 2-21), the control section 1-1 (corresponding to 2-1) and the STM/ATM multiplexing and demultiplexing part 1-23 (corresponding to 2-23) which are shown in FIG. 8, and hence the explanations thereof are omitted.

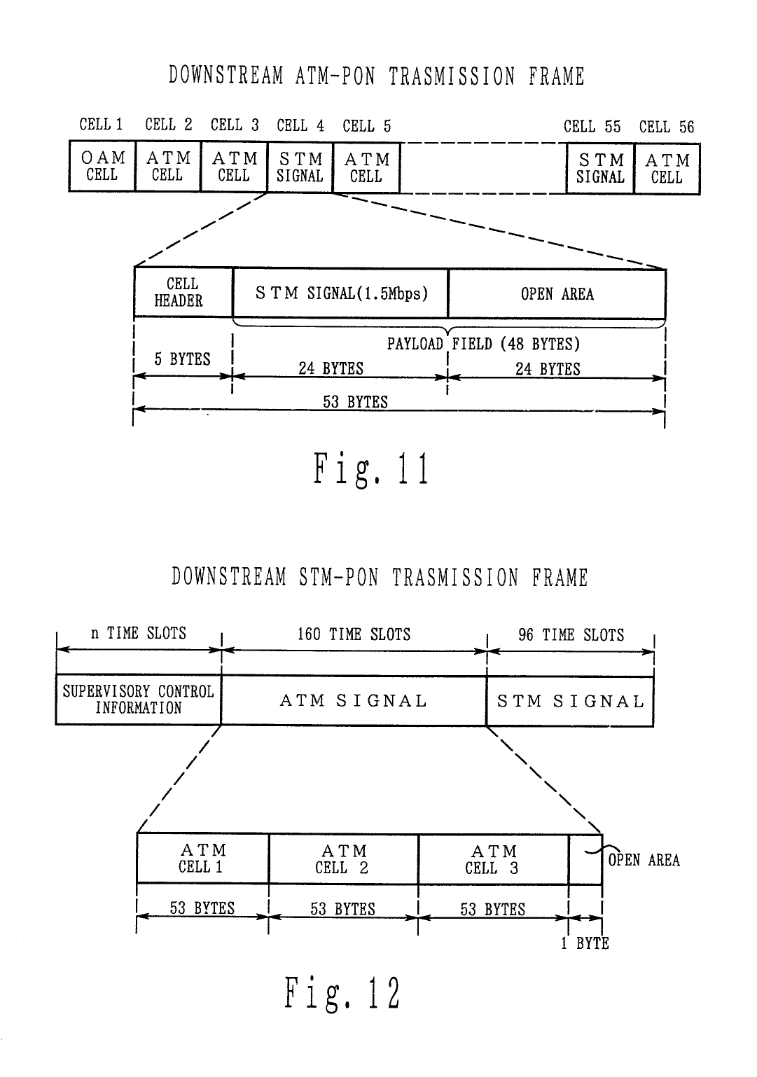

FIG. 11 is a view showing an example of the ATM-PON downstream transmission frame, in which the STM signals are inserted into the ATM-PON downstream transmission frame. In FIG. 11, a cell 1 is an OAM cell, cells 2, 3, 5 to 54, 56 are the ATM cells, and cells 4, 55 are the STM cells. Each of the cells has a fixed length.

As described above, it is designated by the supervisory control information into which cell the STM signal is inserted. In this case, it is suitable to insert the supervisory control information into the OAM cell as the cell 1. Alternatively, it is also suitable to set any cell, except the cell 4 and the cell 55, as the supervisory control information transmission field, and insert the supervisory control information into thus-set cell. Thereby, it becomes possible to insert the supervisory control information into any cells. It is especially useful because the OAM cell does not exist in the ATM-PON upstream transmission frame.

In the example shown in FIG. 11, the STM signals are inserted into the cell 4 and the cell 55. Hence, the insertion of the STM signal into the cell will be explained with the cell 4 being a representative example. In the example shown in FIG. 11, the cell consists of 53 bytes. Five bytes out of the 53 bytes comprise a cell header. Further, 48 bytes which are divided into two of 24 bytes each comprise a payload field. The STM signal is mapped to the payload field due to the following reason. When, for example, information of a primary rate interface at a communication rate of 1.5 Mbps is mapped thereto, the number of channels becomes 24 channels (1 channel (64 kbps)=8 bits=1 byte). Therefore, the payload field (24 bytes) on the cell is used.

FIG. 12 is a view showing an example of the STM-PON downstream transmission frame, in which the ATM signal is inserted into the STM-PON downstream transmission frame. As shown in the drawing, 160 time slots which are designated by the supervisory control information shown in FIG. 12 are used for transmitting the ATM signal, and 96 time slots designated thereby are used for transmitting the STM signal. Further, ATM cells 1 to 3 are inserted into the ATM signal transmission field of the 160 time slots, the remaining of which is a space area.

As is clear from the above concrete example, the ATM cells are generally mapped to the payload field in the STM-PON transmission frame, which is designated for transmitting the ATM signals, according to the supervisory control information.

The processing of sending/receiving the ATM-PON transmission frame and the STM-PON transmission frame and the assembly of the ATM-PON transmission frame and the STM-PON transmission frame are executed in the STM/ATM multiplexing and demultiplexing part 2-23 in the PMDX part 2-2A of the optical line terminator (H-OLT) 2 and in the STM/ATM a multiplexing and demultiplexing part 1-23 in the PMDX part 1-2A of the optical network unit (H-ONU) 1.

Hereinafter, the explanation will be made taking the case in which the STM signal is inserted into the ATM-PON transmission frame as an example.

Each of the STM/ATM multiplexing and demultiplexing part 1-23 and the STM/ATM multiplexing and demultiplexing part 2-23 includes a random access memory which has, for example, a capacity of 256 bytes or more. When the STM signal is inserted into the ATM-PON transmission frame, the STM/ATM multiplexing and demultiplexing part 1-23 or the STM/ATM multiplexing and demultiplexing part 2-23 writes the STM signal in the random access memory in a clock cycle of, for example, 8 kHz, while taking frame synchronization with STM. Further, the STM/ATM multiplexing and demultiplexing part 1-23 or the STM/ATM multiplexing and demultiplexing part 2-23 asynchronously reads the ATM cell out of the random access memory, when data is not written in the random access memory. On this occasion, the STM/ATM multiplexing and demultiplexing part 1-23 or the STM/ATM multiplexing and demultiplexing part 2-23 inhibits the read-out from the random access memory when the write data exists and data is being written therein. The STM signal which is read out as the ATM cell is inserted into the ATM cell of a predetermined number, according to the control information from the control section 1-1 or 2-1.

When the optical network unit (H-ONU) 1 or the optical line terminator (H-OLT) 2 receives the ATM-PON transmission frame into which the aforesaid STM signal is inserted, the STM signal is extracted therefrom as follows.

In the receiving, the STM/ATM multiplexing and demultiplexing part 1-23 or the STM/ATM multiplexing and demultiplexing part 2-23 writes data in the asynchronous ATM cell into the random access memory, and reads out in a clock cycle of, for example, 8 kHz, while taking frame synchronization with STM. The number of the ATM cell into which the STM signal is stored is determined by the control information from the control section 1-1 or 2-1, which makes it possible to facilitate the extraction. Here, the read-out is inhibited when the random access memory is full or data is being written therein.

The procedure for inserting the ATM signal into the STM-PON transmission frame is as follows.

The STM/ATM multiplexing and demultiplexing part 1-23 and the STM/ATM multiplexing and demultiplexing part 2-23 write the ATM signal into the random access memory. Subsequently, the STM/ATM multiplexing and demultiplexing part 1-23 and the STM/ATM multiplexing and demultiplexing part 2-23 insert the ATM signal which is read out from the random access memory into the time slot which is designated by the control information from the control section 1-1 or 2-1.

When the optical network unit (H-ONU) 1 or the optical line terminator (H-OLT) 2 receives the STM-PON transmission frame into which the ATM signal is inserted, the ATM signal is extracted therefrom as follows.

In the receiving, the STM/ATM multiplexing and demultiplexing part 1-23 or the STM/ATM multiplexing and demultiplexing part 2-23 writes the time slot of the ATM signal into the random access memory from the STM-PON transmission frame. The time slot into which the ATM signal is inserted is determined by the control information from the control section 1-1 or 2-1, which makes it possible to facilitate the extraction.

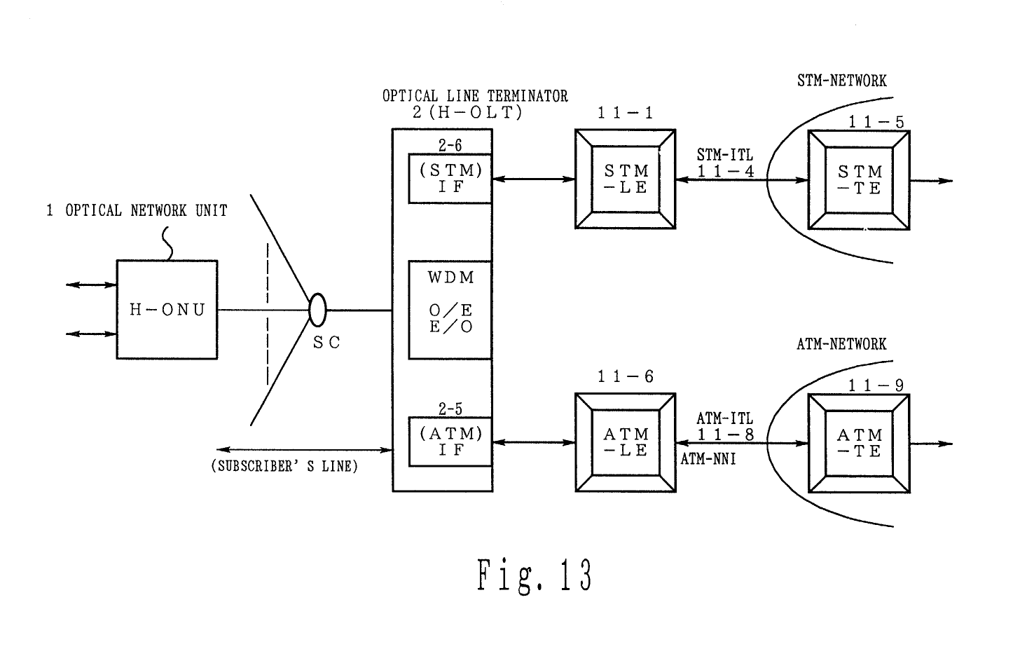

FIG. 13 shows integration of an STM network and an ATM network on a subscriber's line, according to this embodiment.

That is, the optical network unit (H-ONU) 1 and the optical line terminator (H-OLT) 2 to which the present invention is applied are provided to the subscriber's line so that the STM network and the ATM network on the subscriber's line are integrated. In FIG. 13, the same numerals are given to the parts corresponding to those in FIG. 6 and the like, and the explanation thereof is omitted. Note that WDM in the optical line terminator (H-OLT) 2 stands for a wavelength division multiplexing equipment, and O/E and E/O stand for an optic/electric converting part and an electric/optic converting part, respectively.

As methods of the integration, there are a method of integrating the subscriber's line by ATM-PON, and a method of integrating it by STM-PON.

As is clear from the above explanation, according to this embodiment, the ATM-PON transmission frame and the STM-PON transmission frame can be transmitted on the subscriber's line with the ATM signals and the STM signals coexisting therein, and the ATM network and the STM network on the subscriber's line can be integrated with either one of these.

The invention is not limited to the above embodiments and various modifications may be made without departing from the spirit and scope of the invention. Any improvement may be made in part or all of the components.

What is claimed is:

1. A PON transmission system connecting an optical line terminator on a local exchange side and a plurality of optical network units on a subscriber side, using fiber-optic cables and an optical star coupler therebetween, wherein:
said optical line terminator on the local exchange side comprises PON transmitting means on the local exchange side for sending out a PON downstream transmission frame to the fiber-optic cable and for receiving a PON upstream transmission frame from the fiber-optic cable,
the PON downstream transmission frame having
an STM signal transmission field set in units of cells and an ATM signal transmission field set in units of cells coexisting therein,
a supervisory control information transmission field storing information on making allocation of said signal transmission fields in units of cells, designating a way to make the STM signal transmission field and the ATM signal transmission field coexist, and
a plurality of cells having fixed lengths, and the PON upstream transmission frame having
the STM signal transmission field set in units of cells and the ATM signal transmission field set in units of cells coexisting therein,
the supervisory control information transmission field storing information on making allocation to said transmission fields in units of cells, designating the way to make the STM signal transmission field and the ATM signal transmission field coexist, and
the plurality of cells having fixed lengths; and
said optical network unit on the subscriber side comprises PON transmitting means on the local exchange side for sending out a PON upstream transmission frame to the fiberoptic cable and for receiving a PON downstream transmission frame from the fiber-optic cable,
the PON upstream transmission frame having
the STM signal transmission field set in units of cells and an ATM signal transmission field set in units of cells coexisting therein,
the supervisory control information transmission field storing information on making allocation to said transmission fields in units of cells, designating the way to make the STM signal transmission field and the ATM signal transmission field coexist, and
the plurality of cells having fixed lengths, and the PON downstream transmission frame having
the STM signal transmission field set in units of cells and the ATM signal transmission field set in units of cells coexisting therein,
the supervisory control information transmission field storing information on making allocation to said transmission fields in units of cells, designating the way to make the STM signal transmission field and the ATM signal transmission field coexist, and
the plurality of cells having fixed lengths.

2. The PON transmission system according to claim 1, wherein:
said PON transmitting means on the subscriber side requests the optical line terminator on the local exchange side to set the STM signal transmission field and the ATM signal transmission field on said PON downstream transmission frame, by using a supervisory control information transmission field on the PON upstream transmission frame;
said PON transmitting means on the local exchange side sets the STM signal transmission field and the ATM signal transmission field according to the request, and notifies said PON transmitting means on the subscriber side by using the supervisory control information transmission field on the PON downstream transmission frame; and
said PON transmitting means on the subscriber side and said PON transmitting means on the local exchange side send and receive an STM signal and an ATM signal according to the setting.

3. An ATM-PON transmission system connecting an optical line terminator on a local exchange side and a plurality of optical network units on a subscriber side, using fiber-optic cables and an optical star coupler therebetween, wherein:
said optical line terminator on the local exchange side comprises ATM-PON transmitting means on the local exchange side
for providing a cell in an ATM-PON downstream transmission frame for storing supervisory control information in order to store instructional information to accommodate an STM signal in an ATM-PON transmission frame,
for sending out the ATM-PON downstream transmission frame to the fiber-optic cable with the STM signal transmission field and an ATM signal transmission field coexisting therein according to the instructional information, and
for receiving an ATM-PON upstream transmission frame from the fiber-optic cable with the STM signal transmission field and the ATM signal transmission field coexisting therein according to the instructional information; and wherein
said optical network unit on the subscriber side comprises ATM-PON transmitting means on the subscriber side for sending out the ATM-PON upstream transmission frame to the fiber-optic cable with the STM signal transmission field and the ATM signal transmission field coexisting therein according to the instructional information, and for receiving the ATM-PON downstream transmission frame from the fiber-optic cable with the STM signal transmission field and the ATM signal transmission field coexisting therein.

4. An optical network unit of an ATM-PON transmission system connecting an optical line terminator on a local exchange side and a plurality of optical network units on a subscriber side, using fiber-optic cables and an optical star coupler therebetween, comprising:
extracting means for extracting instructional information to accommodate an STM signal in an ATM-PON transmission frame, said instructional information being stored in a cell which is for storing supervisory control information and which is in the ATM-PON transmission frame sent out from the optical line terminator on the local exchange side; and
transmitting means for inserting the STM signal into the cell according to the extracted instructional information, and for transmitting the ATM-PON transmission frame with the STM signal and an ATM signal coexisting therein.

5. An optical line terminator of an ATM-PON transmission system connecting an optical line terminator on a local exchange side and a plurality of optical network units on a subscriber side, with using fiber-optic cables and an optical star coupler therebetween, comprising:
transmitting means for storing instructional information to accommodate an STM signal in a cell in an ATM-PON transmission frame for storing supervisory control information, for inserting the STM signal into the cell in the ATM-PON transmission frame, according to the instructional information, and for transmitting the STM signal and an ATM signal coexisting in the ATM-PON transmission frame.
